(19) United States
(12) Patent Application Publication
(10) Pub. No.: US 2015/0115524 A1
(43) Pub. Date: Apr. 30, 2015

(54) SHEET DISCHARGE DEVICE AND IMAGE FORMING APPARATUS PROVIDED WITH THE SHEET DISCHARGE DEVICE

(71) Applicant: KYOCERA Document Solutions Inc., Osaka (JP)

(72) Inventor: Shota ONISHI, Osaka (JP)

(21) Appl. No.: 14/517,086

(22) Filed: Oct. 17, 2014

(30) Foreign Application Priority Data
Oct. 28, 2013 (JP) 2013-223095

(51) Int. Cl. B65H 29/70; B65H 29/12; B65H 29/14; G03G 15/00

(52) U.S. Cl. CPC B65H 29/70; G03G 15/6552; B65H 29/125; B65H 29/14
USPC 271/182

(57) ABSTRACT

A sheet discharge device includes a sheet discharge roller, a driven roller and a restraint member. A sheet is discharged in a specified discharge direction while passing through a nip portion between the sheet discharge roller and the driven roller. The restraint member is disposed adjacent to the driven roller in a sheet width direction orthogonal to the discharge direction. The restraint member makes contact with a sheet surface of the sheet. When the sheet passes through the nip portion, if the pressing force received from the sheet is equal to or larger than a predetermined value, the restraint member is slid in the sheet width direction by the pressing force.

### CROSS-REFERENCE TO RELATED APPLICATION(S)

This application is based upon and claims the benefit of priority from Japanese Patent Application No. 2013-223095 filed on Oct. 28, 2013, the entire contents of which are incorporated herein by reference.

### BACKGROUND

The technology of the present disclosure relates to a sheet discharge device for discharging a sheet and an image forming apparatus provided with the sheet discharge device.

Conventionally, in an image forming apparatus for forming an image on a sheet, a toner image is formed on the sheet by an image forming unit and, then, a fixing process of the toner image is implemented by a fixing unit. Thereafter, the sheet is discharged to a sheet discharge part. As a sheet discharge device for discharging a sheet to a sheet discharge part, there is disclosed a device including a discharge roller. The sheet discharge device further includes a resilience-applying member. The resilience-applying member is disposed at the upstream side of the discharge roller so as to protrude toward a sheet conveyance path.

In a state in which the resilience-applying member is biased by the compression coil spring, the resilience-applying member is supported by a holding member so as to displace in a protruding direction. Since the protruding amount of the resilience-applying member varies depending on the sliding contact pressure with the sheet, resilience is applied to the sheet and the deflection of the sheet is corrected.

### SUMMARY

A sheet discharge device according to one aspect of the present disclosure includes a first discharge roller, a second discharge roller and a restraint member. The first discharge roller is rotated about a shaft and is configured to discharge a sheet in a specified discharge direction. The second discharge roller is disposed to face the first discharge roller. The second discharge roller is rotated about a shaft. The first discharge roller and the second discharge roller are configured to form therebetween a nip portion through which the sheet passes. The restraint member is disposed adjacent to the second discharge roller in a sheet width direction orthogonal to the discharge direction. The restraint member is configured to make contact with a sheet surface of the sheet. When the sheet passes through the nip portion, if a pressing force received from the sheet is equal to or larger than a predetermined value, the restraint member is slid in the sheet width direction by the pressing force.

An image forming apparatus according to another aspect of the present disclosure includes an image forming unit which forms an image on a sheet and the sheet discharge device which discharges the sheet on which the image is formed.

### BRIEF DESCRIPTION OF THE DRAWINGS

FIG. 1 is a perspective view of an image forming apparatus according to an embodiment.

FIG. 2 is an internal sectional view of the image forming apparatus according to the embodiment.

FIG. 3 is a front view of a signal detection unit 4 according to the embodiment.

FIG. 4 is an enlarged perspective view of the surrounding of a restraint member according to the embodiment.

FIG. 5 is a perspective view showing a deflection formed in a sheet.

FIG. 6 is a perspective view of the restraint member when a first sheet passes through a nip portion.

FIG. 7 is a perspective view of the restraint member when a second sheet passes through the nip portion.

FIG. 8 is a perspective view of another restraint member which is compared with the restraint member according to the embodiment.

FIG. 9 is a front view showing a state in which the deflection of a sheet is corrected by another restraint member which is compared with the restraint member according to the embodiment.

### DETAILED DESCRIPTION

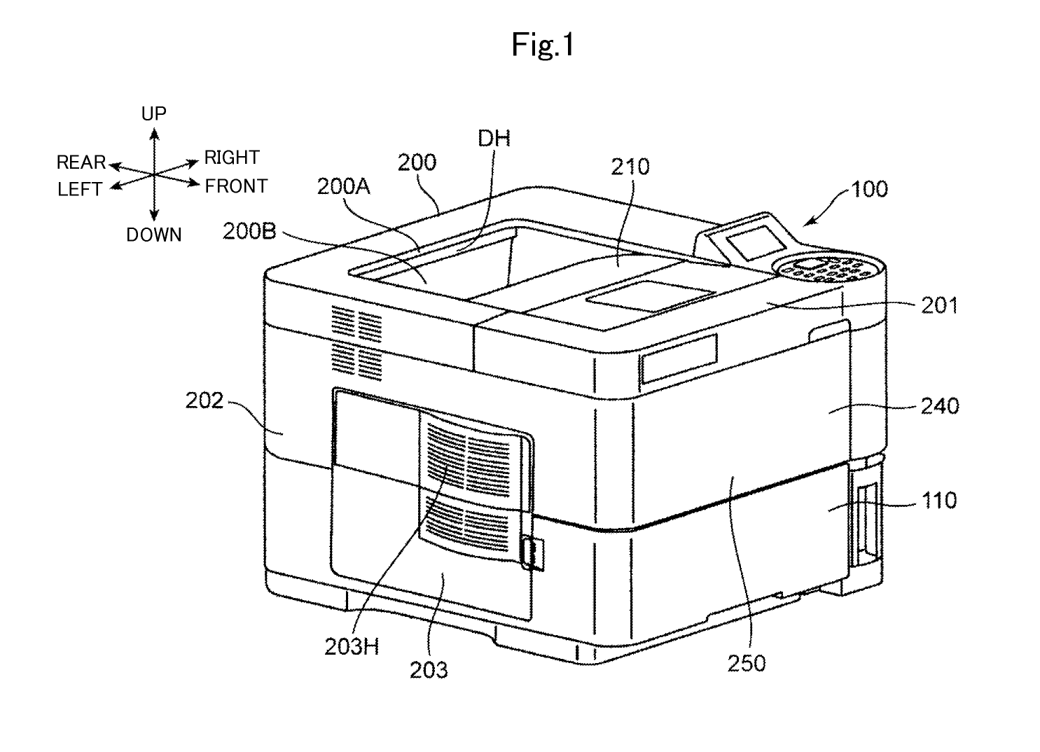

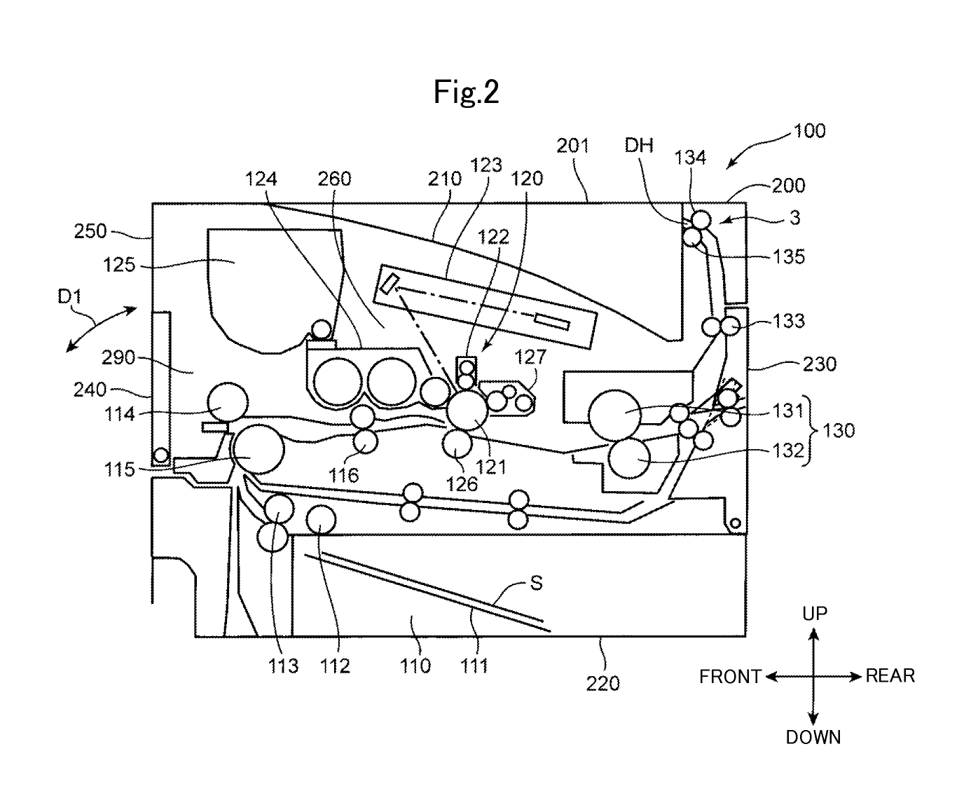

Embodiments of the present disclosure will now be described in detail with reference to the accompanying drawings. FIG. 1 is a perspective view of a printer 100 (an image forming apparatus) according to an embodiment. FIG. 2 is a sectional view schematically showing the internal structure of the printer 100 shown in FIG. 1. The printer 100 shown in FIGS. 1 and 2 is a so-called monochrome printer. In other embodiments, the image forming apparatus may be a color printer, a facsimile machine, a multifunction peripheral provided with the functions of the color printer and the facsimile machine, or other apparatuses for forming a toner image on a sheet. In the following description, the terms which indicate the directions “up” or “down”, “front” or “rear” and “left” or “right” are used to merely clarify the description and are not intended to limit the principle of the image forming apparatus.

The printer 100 includes a housing 200 that accommodates different devices for forming an image on a sheet S. The housing 200 is defined by a plurality of outer walls. The housing 200 includes a top wall 201 which defines a top surface of the housing 200, a bottom wall 220 (see FIG. 2) which defines a bottom surface of the housing 200, a rear wall 230 (see FIG. 2) which vertically extends between the top wall 201 and the bottom wall 220, and a front wall 250 which vertically extends at the opposite side from the rear wall 230. The housing 200 includes a body internal space 260 (an internal space) within which different kinds of devices are disposed.

A sheet discharge part 210 is disposed in the central portion of the top wall 201. The sheet discharge part 210 is formed of a slant surface inclined downward from the front portion of the top wall 201 to the rear portion thereof. The sheet S on which an image is formed in a below-mentioned image forming unit 120 is discharged to the sheet discharge part 210. A manual insertion tray 240 is disposed in the vertical central portion of the front wall 250. The manual insertion tray 240 can be rotated up and down about the lower end thereof (see and arrow D1 in FIG. 2). If the upper end side of the manual insertion tray 240 is rotated downward, an opening portion 290 formed in the housing 200 is opened. The opening portion 290 communicates with the body internal space 260 of the housing 200. A user can gain access to the different devices accommodated within the body internal space 260 of the housing 200 through the opening portion 290. If the manual insertion tray 240 is rotated upward, the opening portion 290 is closed. As a result, the user is prevented from unnecessarily gaining access to the body internal space 260.

The printer 100 includes a cassette 110, a pickup roller 112, a first sheet-feeding roller 113, a second sheet-feeding roller 114, a conveying roller 115, a registration roller pair 116 and an image forming unit 120.

The cassette 110 accommodates sheets S therein. The cassette 110 includes a lift plate 111 which supports the sheets S. The lift plate 111 is inclined so as to push up the frontal edges of the sheets S.

The pickup roller 112 is disposed above the frontal edges of the sheets S pushed up by the lift plate 111. If the pickup roller 112 rotates, the sheet S is drawn out from the cassette 110.

The first sheet-feeding roller 113 is arranged at the downstream side of the pickup roller 112. The first sheet-feeding roller 113 sends the sheet S toward the more downstream side. The second sheet-feeding roller 114 is arranged near the fulcrum of the manual insertion tray 240. The second sheet-feeding roller 114 brings the sheet S existing on the manual insertion tray 240 into the housing 200. A user can selectively use the sheet S accommodated within the cassette 110 or the sheet S placed on the manual insertion tray 240.

The conveying roller 115 is arranged at the downstream side of the first sheet-feeding roller 113 and the second sheet-feeding roller 114. The conveying roller 115 conveys the sheet S, which is sent by the first sheet-feeding roller 113 or the second sheet-feeding roller 114, toward the more downstream side.

The registration roller pair 116 defines a sheet position in the conveyance direction. Thus, the position of an image formed on the sheet S is adjusted. The registration roller pair 116 supplies the sheet S to the image forming unit 120 in keeping with the timing of image formation performed by the image forming unit 120.

The image forming unit 120 is disposed within the body internal space 260. The image forming unit 120 forms an image on the sheet. The image forming unit 120 includes a photosensitive drum 121, a charger 122, an exposure device 123, a developing device 124, a toner container 125, a transfer roller 126 and a cleaning device 127.

The photosensitive drum 121 has a cylindrical shape. The photosensitive drum 121 has a circumferential surface on which an electrostatic latent image is formed. The photosensitive drum 121 carries a toner image corresponding to the electrostatic latent image.

A specified voltage is applied to the charger 122. The charger 122 serves to substantially uniformly charge the circumferential surface of the photosensitive drum 121.

The exposure device 123 irradiates laser light on the circumferential surface of the photosensitive drum 121 charged by the charger 122. The laser light is irradiated pursuant to the image data outputted from an external device (not shown) such as a personal computer communicatively connected to the printer 100. As a result, an electrostatic latent image corresponding to the image data is formed on the circumferential surface of the photosensitive drum 121.

The developing device 124 supplies a toner on the circumferential surface of the photosensitive drum 121 on which the electrostatic latent image is formed. The toner container 125 supplies the toner to the developing device 124. If the developing device 124 supplies the toner to the photosensitive drum 121, the electrostatic latent image formed on the circumferential surface of the photosensitive drum 121 is developed (visualized). As a result, a toner image is formed on the circumferential surface of the photosensitive drum 121.

The transfer roller 126 is rotatably arranged so as to make contact with the circumferential surface of the photosensitive drum 121. When the sheet S conveyed from the registration roller pair 116 passes through between the photosensitive drum 121 and the transfer roller 126, the toner image formed on the circumferential surface of the photosensitive drum 121 is transferred to the sheet S.

The cleaning device 127 removes the toner which remains on the circumferential surface of the photosensitive drum 121 after the toner image is transferred to the sheet S. The circumferential surface of the photosensitive drum 121 cleaned by the cleaning device 127 is passed below the charger 122 again and is uniformly charged. Thereafter, the formation of the aforementioned toner image is newly performed.

The printer 100 further includes a fixing device 130 arranged at the more downstream side than the image forming unit 120 in the conveyance direction and configured to fix the toner image to the sheet S. The fixing device 130 includes a heating roller 131 for melting the toner existing on the sheet S and a pressing roller 132 for pressing the sheet S against the heating roller 131. If the sheet S passes through between the heating roller 131 and the pressing roller 132, the toner image is fixed to the sheet S.

The printer 100 includes a plurality of conveying roller pairs 133 arranged at the downstream side of the fixing device 130, and a sheet discharge unit 3. The sheet S is conveyed upward by the conveying roller pairs 133 and is finally discharged from the discharge hole DH (see FIG. 1) of the housing 200 by the sheet discharge unit 3. The sheet S discharged from the discharge hole DH is stacked on the sheet discharge part 210.

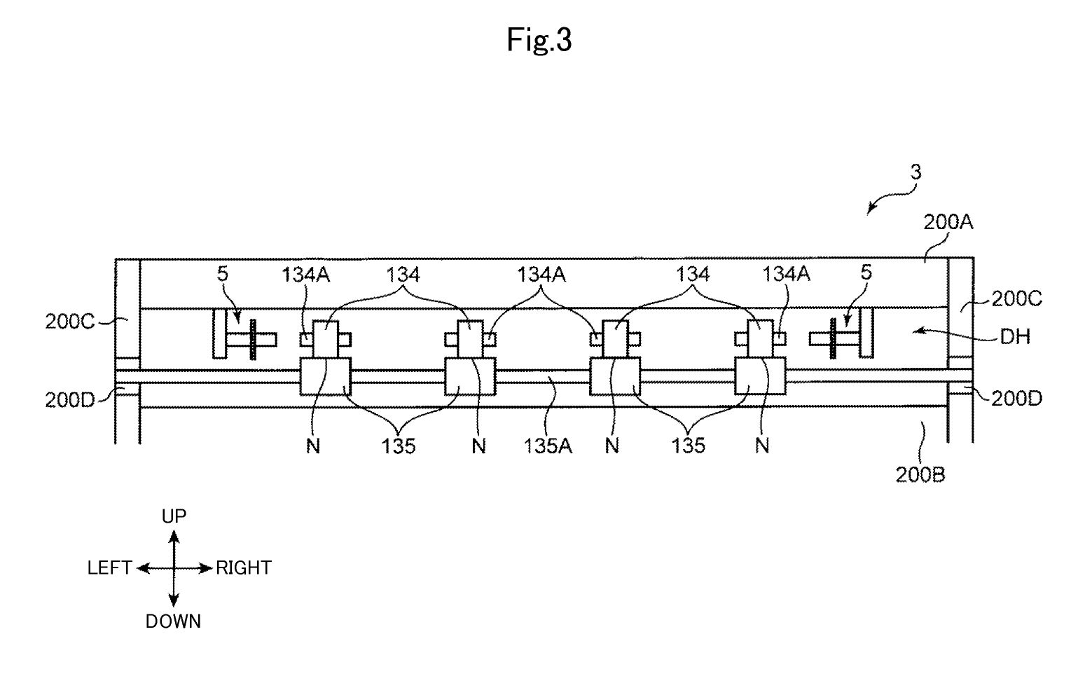

Next, the sheet discharge unit 3 according to the present embodiment will be described in detail with reference to FIGS. 1, 2 and 3. FIG. 3 is a front view of the sheet discharge unit 3 according to the present embodiment. The printer 100 includes a housing top wall portion 200A, a housing base portion 200B and side plate frames 200C. The housing top wall portion 200A is a ceiling plate of the housing 200. The housing base portion 200B is a wall portion of the housing 200 which is vertically installed below the housing top wall portion 200A at the rear side of the sheet discharge part 210. The side plate frames 200C are frames that interconnect the left and right ends of the housing top wall portion 200A and the housing base portion 200B in the up-down direction. As shown in FIG. 3, the discharge hole DH from which the sheet S is discharged is formed in a region whose upper, lower, left and right sides are surrounded by the housing top wall portion 200A, the housing base portion 200B and the side plate frames 200C. Each of the side plate frames 200C includes a bearing portion 200D.

The sheet discharge unit 3 includes sheet discharge rollers 135 (first discharge rollers), a sheet discharge roller shaft 135A, driven rollers 134 (second discharge rollers), driven roller shafts 134A and restraint units 5.

The sheet discharge rollers 135 rotate about the sheet discharge roller shaft 135A and discharges the sheet in a specified discharge direction (a front direction). As shown in FIG. 3, four sheet discharge rollers 135 are disposed along the left-right direction. The sheet discharge roller shaft 135A supports the sheet discharge rollers 135 and serves as a rotation shaft during the rotation of the sheet discharge rollers 135. The opposite end portions of the sheet discharge roller shaft 135A in the left-right direction are rotatably supported by the bearing portions 200D mentioned above. A drive mechanism not shown is connected to the sheet discharge roller shaft 135A. The sheet discharge rollers 135 are rotationally driven by the drive mechanism.

The driven rollers 134 are disposed so as to face the sheet discharge rollers 135. The driven rollers 134 rotate about the driven roller shafts 134A and form nip portions N with the sheet discharge rollers 135, the sheet S passing through the nip portions N. As shown in FIG. 3, four driven rollers 134 are disposed along the left-right direction. The driven roller shafts 134A support the driven rollers 134 and serve as rotation shafts during the rotation of the driven rollers 134. Each of the driven roller shafts 134A is supported on a holder (not shown) provided with a bearing. The holder is fixed to a frame (not shown) disposed at the side of the housing top wall portion 200A. In the present embodiment, the driven rollers 134 are rotated by the sheet discharge rollers 135. The driven rollers 134 are biased toward the sheet discharge rollers 135 by springs (not shown).

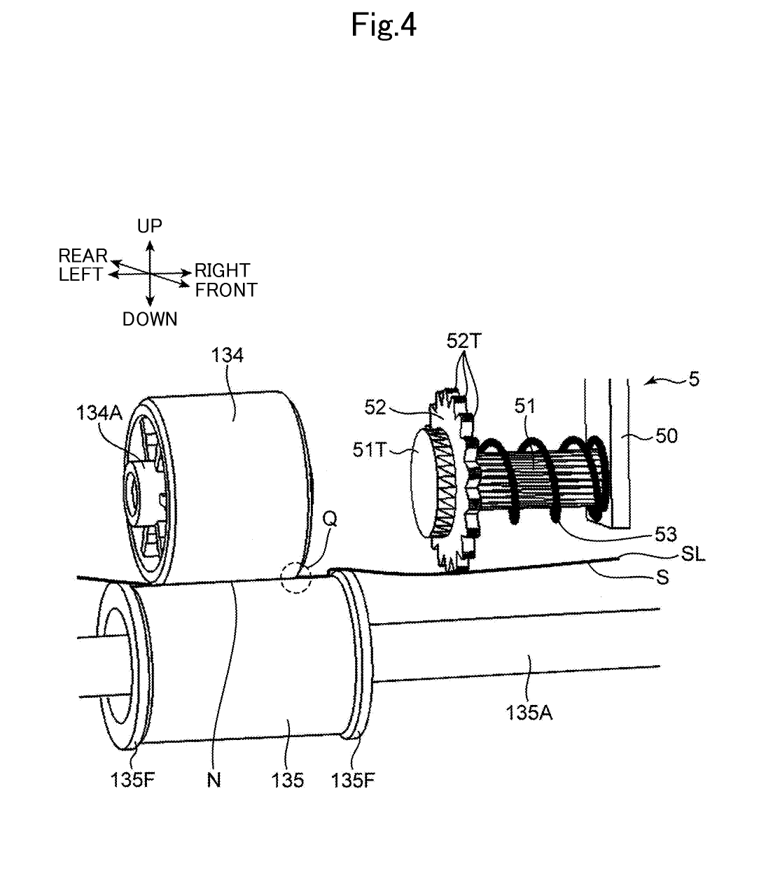

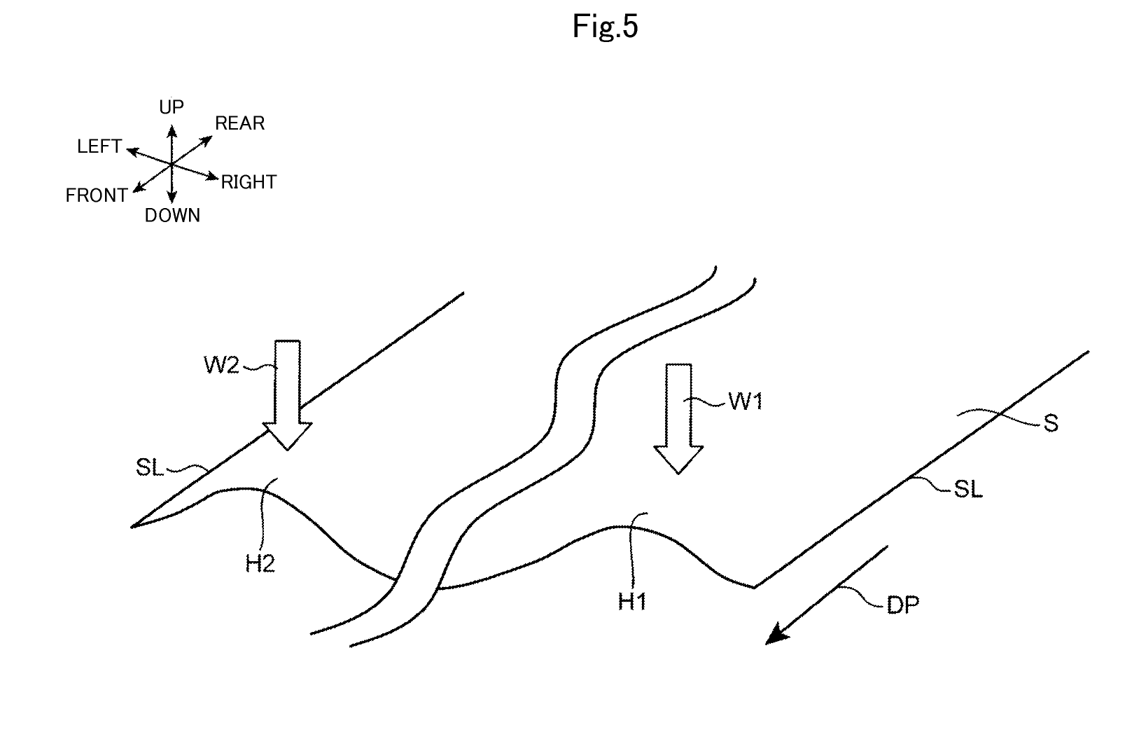

FIG. 4 is an enlarged perspective view of the surrounding of a restraint member 52 of each of the restraint units 5 according to the embodiment. FIG. 5 is a perspective view showing a deflection formed in the sheet S. In FIG. 5, the sheet S is discharged in the sheet discharge direction (the direction indicated by an arrow DP). Each of the restraint units 5 serves to correct the deflection (curl) of the sheet S. In other words, each of the restraint units 5 has a resilience-applying function by which resilience is applied to the sheet S.

When the sheet S is heated in the fixing device 130, a water vapor is evaporated from the inside of the sheet S. Therefore, a deflection is easy to generate in the sheet S. Similarly, in the section between the fixing device 130 and the sheet discharge part 210, the sheet S is easily deflected by an external force applied to the sheet S. Referring to FIG. 4, in the present embodiment, the width of the driven rollers 134 in the sheet width direction is set smaller than the width of the sheet discharge rollers 135 in the sheet width direction. As shown in FIG. 4, flange portions 135F are disposed at the opposite ends of each of the sheet discharge rollers 135 in the sheet width direction. Therefore, the sheet surface existing more outward than each of the nip portions N in the sheet width direction makes contact with each of the flange portions 135F and warps upward. On the other hand, the edge portion SL of the sheet S in the sheet width direction is not restrained by a roller and is therefore easy to sag downward by the gravity. As a result, as shown in FIG. 5, deflection portions H1 and H2 partially protruding upward are easy to generate in the opposite end portions of the sheet S in the sheet width direction. That is to say, the sheet S is easily deflected in a waveform.

Even if the flange portions 135F are not disposed, the deflection of the sheet S is easy to generate. That is to say, if the width of the driven rollers 134 in the sheet width direction is set smaller than the width of the sheet discharge rollers 135 in the sheet width direction, the restraining force that restrains the sheet S from above is released in the region Q shown in FIG. 4. Thus, the sheet surface of the sheet S is easily warped upward.

In order to reduce the deflection generated in the sheet S, in the present embodiment, the sheet discharge unit 3 is provided with the restraint units 5. The restraint units 5 are disposed in the opposite end portions of the sheet discharge unit 3 in the sheet width direction. Referring to FIG. 4, each of the restraint units 5 includes a support portion 50, a shaft portion 51, a restraint member 52 and a biasing member 53. Each of the restraint units 5 has a corrugation function by which the curl of the sheet S is restrained.

The support portion 50 is a plate-like member that protrudes downward from the housing top wall portion 200A. The support portion 50 supports the shaft portion 51.

The shaft portion 51 is a cylindrical columnar shaft member extending inward in the sheet width direction from the support portion 50. The shaft portion 51 supports the restraint member 52 so that the restraint member 52 can rotate and can slide in the sheet width direction. The shaft portion 51 is provided with a flange 51T. The flange 51T is a flange portion disposed in the tip portion of the shaft portion 51. The flange 51T has a removal-preventing function by which the restraint member 52 is prevented from being removed from the shaft portion 51.

The restraint member 52 is a disc member (disc portion) which is rotatable about the shaft portion 51. The restraint member 52 is disposed in an adjoining (opposing) relationship with one of the driven rollers 134 in the sheet width direction orthogonal to the sheet discharge direction. The restraint member 52 makes contact with the sheet surface of the sheet S. At this time, the restraint member 52 comes into contact the sheet surface of the sheet S with which the driven rollers 134 make contact. As will be described later, if the pressing force received from the sheet S becomes equal to or larger than a predetermined value when the sheet S passes through the nip portions N, the restraint member 52 is slid in the sheet width direction by the pressing force. The restraint member 52 includes a plurality of protrusion portions 52T disposed in the outer circumferential portion thereof at a specified interval in a circumferential direction and configured to make contact with the sheet surface of the sheet S.

In the present embodiment, the restraint member 52 is made of a rubber member (elastic member). Thus, the restraint member 52 can be compressed and deformed radially inward. In another embodiment, the outer circumferential portion (the protrusion portions 52T) of the restraint member 52 may be made of an elastic member that can be compressed and deformed radially inward and the remaining portion of the restraint member 52 may be made of an ABS resin or the like.

The biasing member 53 is a coil spring externally fitted to the shaft portion 51. The biasing member 53 is disposed between the restraint member 52 and the support portion 50 in a compressed state. The biasing member 53 biases the restraint member 52 toward the nip portions N in the sheet width direction.

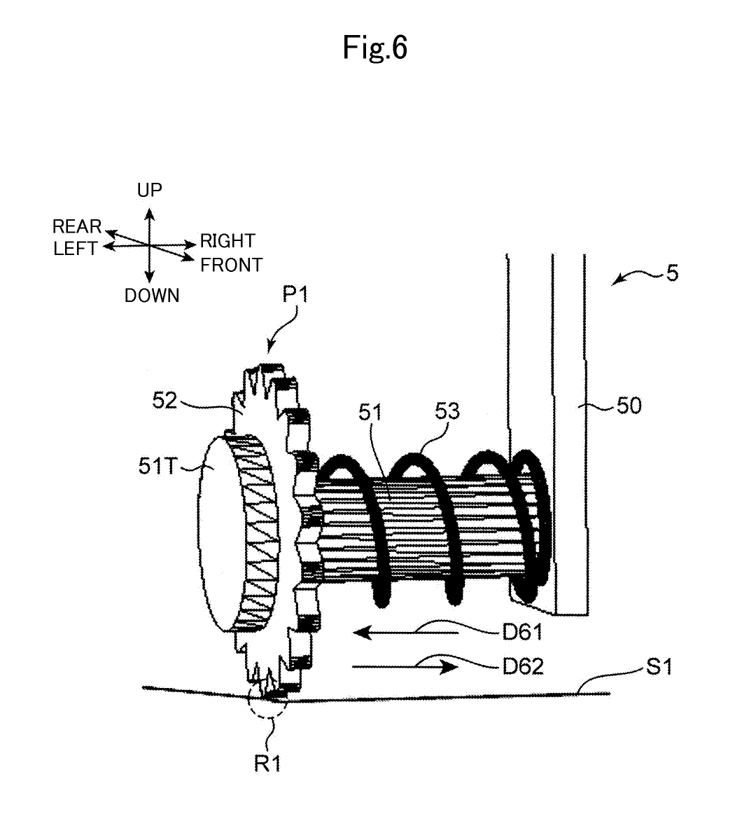

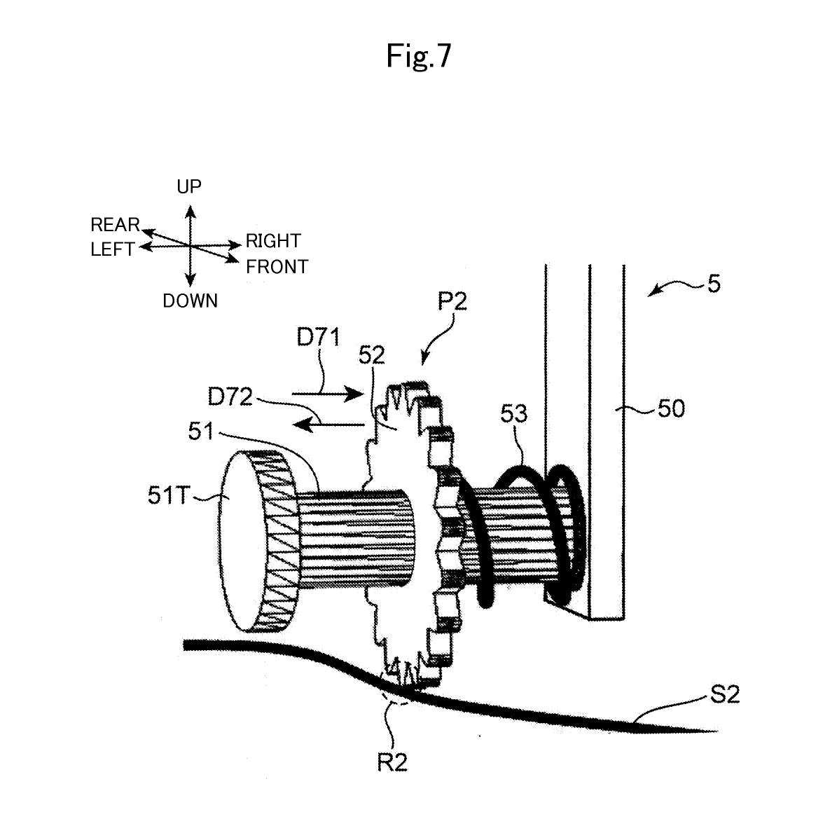

Next, description will be made on the operation of the restraint member 52 according to the present embodiment. FIG. 6 is a perspective view of the restraint unit 5 in a first state in which a first sheet S1 having a first rigidity passes through the nip portions N. FIG. 7 is a perspective view of the restraint unit 5 in a second state in which a second sheet S2 having a second rigidity larger than the first rigidity passes through the nip portions N.

In the present embodiment, a plain paper of 64 g/m² in weight is used as the first sheet S1 having a first rigidity. A cardboard of 105 g/m² in weight is used as the second sheet S2 having a second rigidity. The rigidity of the second sheet S2 thicker than the first sheet S1 is larger than the rigidity of the first sheet S1. In other words, the resilience of the second sheet S2 is stronger than the resilience of the first sheet S1. The rigidity of the sheet S does not depend on only the thickness thereof. Even if the sheets have the same thickness, they may have different rigidities in case where the materials or the production methods thereof differ from each other. Furthermore, the rigidity of the sheet S varies depending on the fiber directions (machine direction and cross direction) of the sheet S.

Referring to FIG. 6, when the first sheet S1 passes through the nip portions N (see FIGS. 3 and 4), the restraint member 52 is disposed at a first position P1 in the sheet width direction by a first pressing force received from the first sheet S1. At this time, the restraint member 52 is disposed at a position where the restraint member 52 makes contact with the flange 51T. In the first state shown in FIG. 6, the restraint member 52 makes contact with a sheet surface R1 existing more outward than the nip portions N in the sheet width direction. Thus, the deflection portions H1 and H2 (see FIG. 5) partially protruding upward are prevented from being generated in the regions adjoining the nip portions N of the first sheet S1. As a result, the deflection of the first sheet S1 discharged to the sheet discharge part 210 (see FIG. 1) is reduced.

In the first state shown in FIG. 6, the first pressing force of the first sheet S1 applied to the restraint member 52 and the biasing force of the biasing member 53 are balanced, whereby the restraint member 52 is disposed at the first position P1.

On the other hand, referring to FIG. 7, in the second state in which the second sheet S2 passes through the nip portions N, the second sheet S2 presses the restraint member 52 against the biasing force of the biasing member 53 with a larger pressing force than the pressing force of the first sheet S1 (see an arrow D71 in FIG. 7). As a result, the restraint member 52 is disposed at the second position P2 by the pressing force received from the second sheet S2. In other words, the restraint member 52 is disposed at the second position P2 spaced apart from the nip portions N beyond the first position P1. As set forth above, in the present embodiment, if the pressing force received from the sheet S is equal to or larger than a predetermined value, the restraint member 52 is slid in the sheet width direction by the pressing force.

In the second state shown in FIG. 7, the restraint member 52 makes contact with a sheet surface R2 existing more outward than the nip portions N in the sheet width direction. The sheet surface R2 is positioned more outward than the sheet surface R1 in the sheet width direction. Even in this case, the generation of the deflection portions H1 and H2 (see FIG. 5) partially protruding upward are prevented. As a result, the deflection of the second sheet S2 discharged to the sheet discharge part 210 (see FIG. 1) is reduced. Since the restraint member 52 is spaced apart outward in the sheet width direction from the nip portions N, the restraint member 52 is prevented from making contact with the second sheet S2 with an excessively strong force. As a result, contact marks are prevented from being left on the sheet surface of the second sheet S2. In other words, when the second sheet S2 passes through the nip portions N, if the restraint member 52 is positioned at the first position P1, the deflection of the second sheet S2 having a high rigidity is corrected in a narrow region (between the nip portions N and the restraint member 52) in the sheet width direction. Then, the restraint member 52 makes strong contact with the sheet surface of the second sheet S2. Accordingly, contact marks are easily formed on the sheet surface. In this case, an image defect is generated in the image formed on the second sheet S2.

In the first and second states mentioned above, the restraint member 52 can be rotated by the sheet S (S1 or S2). For that reason, the discharge of the sheet S is promoted and the contact marks are further prevented from being left on the sheet S.

In the present embodiment, a plurality of protrusion portions 52T is disposed in the outer circumferential portion of the disc-shaped restraint member 52. Thus, the contact portions between the restraint member 52 and the sheet S are formed into a dot line shape along the sheet conveyance direction. As a result, even if small contact marks are left on the sheet S, it is difficult for a user to visually recognize the contact marks. Moreover, since the outer circumferential portion (the protrusion portions 52T) of the restraint member 52 is compressively deformed, the contact marks are further prevented from being left on the sheet S.

As mentioned above, if the width of the driven rollers 134 in the sheet width direction is set smaller than the width of the sheet discharge rollers 135 in the sheet width direction, the sheet surface of the sheet S is easily warped upward. Even in this case, the restraint member 52 comes into contact, from above, with the sheet surface with which the driven rollers 134 make contact. It is therefore possible to restrain the deflection (warp) of the sheet S. Moreover, the restraint member 52 is disposed between the nip portions N and one edge (SL) of the sheet S so as to make contact with the end portion of the sheet S. This makes it possible to restrain deflection of the end portion of the sheet S kept in a free state.

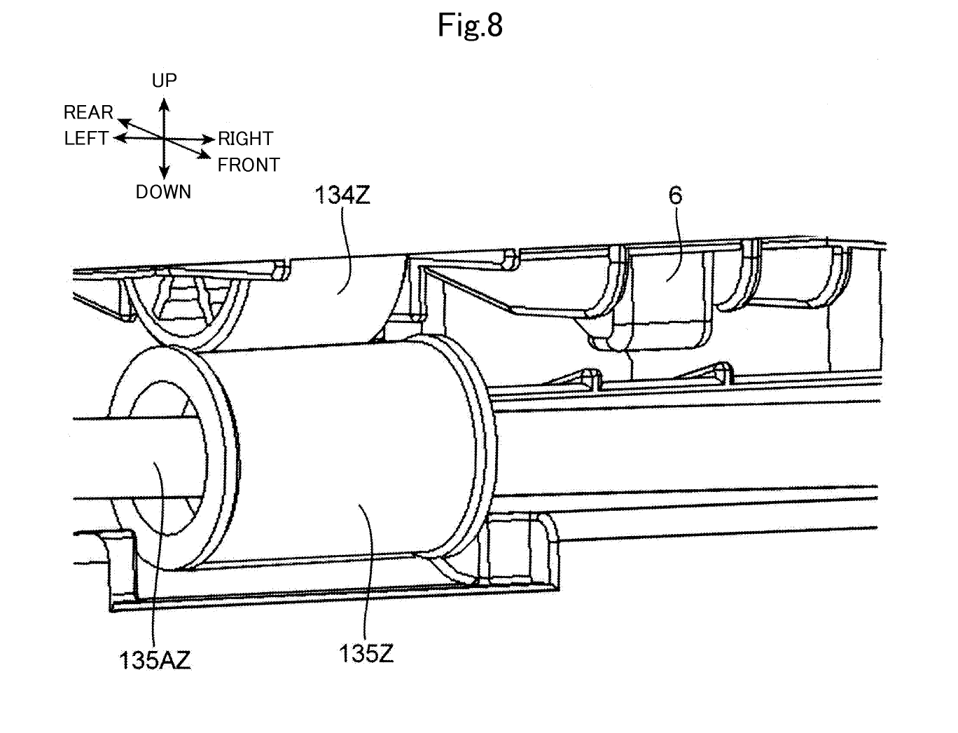

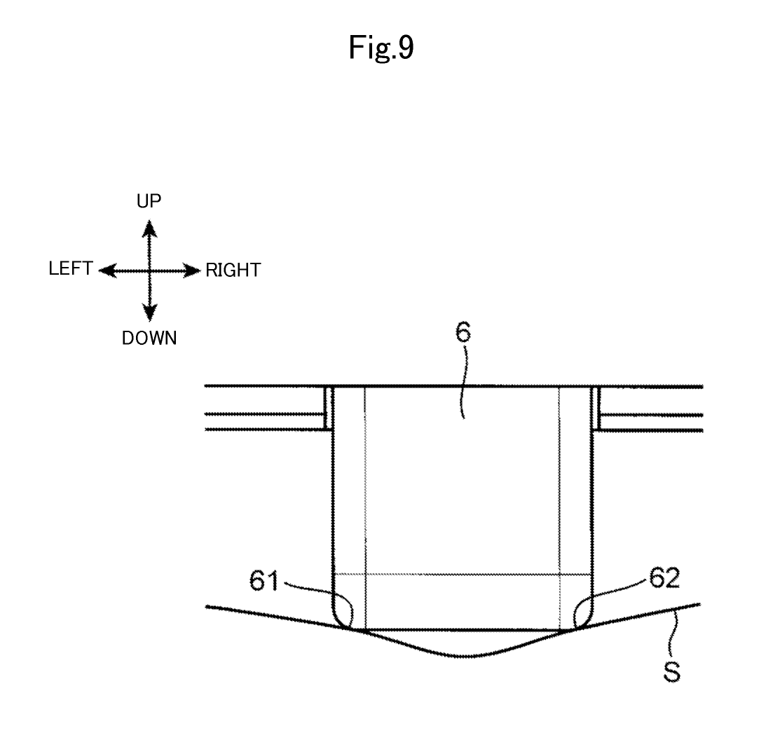

FIG. 8 is a perspective view of another restraint member (a pressing portion 6) which is compared with the restraint member 52 according to the present embodiment. FIG. 9 is a front view showing a state in which the deflection of the sheet is corrected by the pressing portion 6.

Unlike the restraint member 52, the pressing portion 6 is formed into a substantially rectangular parallelepiped shape. The pressing portion 6 is disposed adjacent to the driven rollers 134Z and the sheet discharge rollers 135Z. As shown in FIG. 9, if the pressing portion 6 makes contact with the sheet S, contact flaws are easy to generate in the sheet S at a first pressing point 61 and a second pressing point 62. Particularly, even if the rigidity of the sheet S conveyed is changed, the pressing portion 6 is disposed at the same position in the sheet width direction. For that reason, when a sheet S having a high rigidity (resilience) is conveyed, liner contact marks are formed on the sheet S in a corresponding relationship with the first pressing point 61 and the second pressing point 62. In contrast, according to the restraint member 52 of the present embodiment, as described above, it is possible to suppress formation of contact marks on the sheet S and to prevent the sheet S from being discharged to the sheet discharge part 210 with the deflections remaining in the sheet S.

While the sheet discharge unit 3 according to an embodiment and the printer 100 (the image forming apparatus) provided with the same have been described above, the technology of the present disclosure is not limited thereto. For example, it may be possible to employ the modified embodiments set forth below.

(1) In the aforementioned embodiment, description has been made on the configuration in which the restraint member 52 is disposed at the first position P1 in a corresponding relationship with the first sheet S1 and the restraint member 52 is disposed at the second position P2 in a corresponding relationship with the second sheet S2. However, the technology of the present disclosure is not limited thereto. In case where variations in the rigidity (resilience) exist in the same first sheet S1, it may be possible to employ a configuration in which the restraint member 52 is slid in the sheet width direction depending on the rigidity. If variations exist in the external force received by the sheet S in the conveyance path of the upstream side of the sheet discharge unit 3 in the sheet conveyance direction, there may be a case where different deflections are formed in each of the sheets S when the sheets S are carried into the sheet discharge unit 3. In this case, the restraint member 52 may be configured to slide in the sheet width direction in a corresponding relationship with the individual sheets S.

(2) In the aforementioned embodiment, description has been made on the configuration in which the protrusion portions 52T are disposed in the outer circumferential portion of the restraint member 52. However, the technology of the present disclosure is not limited thereto. It may be possible to employ a configuration in which the outer circumferential portion of the restraint member 52 has a continuous circumferential surface.

(3) In the aforementioned embodiment, description has been made on the configuration in which a pair of restraint members 52 (restraint units 5) is disposed in the opposite end portions of the sheet discharge unit 3 in the sheet width direction. However, the technology of the present disclosure is not limited thereto. Three or more restraint units 5 each including the restraint member 52 may be disposed along the sheet width direction. As one example, it may be possible to employ a configuration in which the restraint units 5 are disposed between the driven rollers 134 shown in FIG. 3. The present disclosure is not limited to the configuration in which the restraint members 52 are disposed at the side of the driven rollers 134. It may be possible to employ a configuration in which the restraint members 52 are disposed at the side of the sheet discharge rollers 135. In addition, the width and shape of the driven rollers 134 and the sheet discharge rollers 135 are not limited to the ones described above.

What is claimed is:

1. A sheet discharge device, comprising:
a first discharge roller rotated about a shaft and configured to discharge a sheet in a specified discharge direction;
a second discharge roller disposed to face the first discharge roller and rotated about a shaft, the first discharge roller and the second discharge roller configured to form therebetween a nip portion through which the sheet passes; and
a restraint member disposed adjacent to the second discharge roller in a sheet width direction orthogonal to the discharge direction, the restraint member configured to make contact with a sheet surface of the sheet,
wherein, when the sheet passes through the nip portion, if a pressing force received from the sheet is equal to or larger than a predetermined value, the restraint member is slid in the sheet width direction by the pressing force.

2. The device of claim 1, wherein when a first sheet having a first rigidity passes through the nip portion, the restraint member is disposed at a first position in the sheet width direction by a first pressing force received from the first sheet, and when a second sheet having a second rigidity larger than the first rigidity passes through the nip portion, the restraint member is disposed at a second position spaced apart from the nip portion beyond the first position in the sheet width direction by a second pressing force received from the second sheet.

3. The device of claim 2, wherein the restraint member is a disc portion, and further comprising:
a shaft portion which extends in the sheet width direction and which supports the disc portion so that the disc portion can rotate and can slide in the sheet width direction; and
a biasing member which biases the disc portion toward the nip portion in the sheet width direction.

4. The device of claim 3, wherein the restraint member is disposed at the first position when the first pressing force of the first sheet applied to the restraint member and the biasing force of the biasing member are balanced, and the restraint member is disposed at the second position when the second pressing force of the second sheet applied on the restraint member which is larger than the first pressing force and the biasing force of the biasing member are balanced.

5. The device of claim 4, wherein the disc portion includes a plurality of protrusion portions disposed in an outer circumferential portion thereof at a specified interval in a circumferential direction and configured to make contact with the sheet surface.

6. The device of claim 3, wherein at least an outer circumferential portion of the disc portion is made of an elastic member which can be compressed and deformed radially inward.

7. The device of claim 1, wherein a width of the second discharge roller in the sheet width direction is set smaller than a width of the first discharge roller in the sheet width direction, and the restraint member comes into contact with the sheet surface of the sheet with which the second discharge roller makes contact.

8. The device of claim 1, wherein the restraint member makes contact with an end portion of the sheet in the sheet width direction.

9. An image forming apparatus, comprising:
an image forming unit which forms an image on a sheet; and
the sheet discharge device of claim 1 which discharges the sheet on which the image is formed.
